(19) United States
(12) Patent Application Publication
(10) Pub. No.: US 2004/0025045 A1
(43) Pub. Date: Feb. 5, 2004

(54) Method for switching rapidly between computing modes

(75) Inventor: Nai Tiong Chan, Singapore (SG)

Correspondence Address: GEORGE O. SAILE & ASSOCIATES, 28 DAVIS AVENUE, POUGHKEEPSIE, NY, 12603, US

(73) Assignee: Sentry Technologies Pte, Ltd.

(21) Appl. No.: 10/209,410

(22) Filed: Jul. 30, 2002

(51) Int. Cl. H04L 9/00

(52) U.S. Cl. 713/200; 713/324

(57) ABSTRACT

A system and method is described to switch from a current computing mode to a next computing mode without the need to perform a lengthy computer reboot. Data integrity is maintained between computing modes such that data from a current mode cannot contaminate data in a next computing mode. When switching between a current computing mode and a next computing mode, the computer is placed into hibernation and context data that is necessary to resume computing in the current mode is saved to a preferably non-volatile storage. Then the computer is switched to the next computing mode, context data of the next mode is restored, and computing is resumed from the point where computing in the next mode was previously stopped.

### BACKGROUND OF THE INVENTION

1. Field of Invention

The present invention is related to computer systems and in particular to switching between computing modes while maintaining security and integrity of each computing mode.

2. Description of Related Art

Computer security and integrity can be compromised when a computer is connected to multiple networks through which hackers can gain access to the computing system. Entry by the hackers is usually through lower security networks allowing access to higher security networks and data. A method to stop this activity is to install multiple computing modes that are separate and isolated from one another, and assigning a computing mode to lower security networks. A computing mode is defined as a configuration of a computing system using one or more computing resources such as network connections, hard disks or hard disk partitions that can be controlled. Each computing mode dictates a subset of the resources that are accessible when operating in the computing mode. In many cases it is desirable to implement computing modes that are separated and isolated such that there is no, or only limited, possibilities for data to be transferred, or leaked, between computing modes.

Several methods have been developed to create multiple computing modes on a single computer. In U.S. Pat. No. 6,141,778 (Kane et al.) a computer security system is directed to automatic updates of access status and level of privilege. A unique user ID is assigned to each user across the computing system. U.S. Pat. No. 6,138,181 (Aida et al.) is directed to a CPU mode switching circuit comprising a power on reset circuit and a mode selector. The power on reset generates a power on reset signal when power is turned on, and the mode selector resets internal data in response to power on reset. U.S. Pat. No. 6,128,682 (Humphreys et al.) is directed to a method and apparatus for bus isolation. A circuit containing a switch and logic to perform the bus isolation is described. In U.S. Pat. No. 5,933,498 (Schneck et al.) a method and device are directed to controlling access, use and distribution of digital data, where access to data is controlled. A secure co-processor is used in countermeasures for tampering. U.S. Pat. No. 5,542,044 (Pope) is directed to a security device for a computer, which includes a communication driver that may be loaded into the computer to partition main storage into a safe storage area.

WO 98/25372 is directed to a method in which a storage unit is divided into multiple sections with each section being used by a different computing mode. In U.S. Pat. No. 6,378,074 B1 (Tiong) a method is directed to use separate physical hard disks for each computing mode. Other approaches include the use of encryption to create areas that are separate and isolated from one another. In all of these approaches the computer goes through a warm or cold reboot when the computer is switched from one computing mode to another to prevent contamination of data between computing modes.

Before a computer is switched to another computing mode active software applications must be closed and their data saved, and then the operating system shut down. When the next computing mode is chosen, the operating system must be rebooted and the software systems and their data files reloaded before the user can continue work. This makes switching the computing mode a tedious task consuming both time and energy to maintain a secure environment.

### SUMMARY OF THE INVENTION

It is an objective of the present invention to switch a computing system between computing modes in a multiple computing mode environment.

It is also an objective of the present invention to switch between computing modes without performing reboot of the system.

It is another objective of the present invention to switch between computing modes without terminating active applications and saving data associated with the applications.

It is yet another objective of the present invention to switch between computing modes without allowing contamination of data between computing modes.

It is still another objective of the present invention to allow the user to return to any computing mode at the point where work was last performed and continue the previous work.

It is still further an objective of the present invention to store context data from a computing mode on a storage media, so that the context data is only accessible in the computing mode from which the context data was saved .

It is still yet another objective of the present invention to store context data from a computing mode on non-volatile storage area.

It is further an objective of the present invention to store context data on a volatile storage area where power to the computer is not interrupted during computing mode switching.

In the present invention a method for switching computing modes is shown without requiring terminating active applications, and rebooting the computer. This is accomplished with the prevention of contamination of data between modes by the leakage of data from one mode to another. The user can quickly switch between computing modes and return to any mode at the point where work was stopped when the computing mode was last used.

In the preferred embodiment of the present invention the context of the computer in the current computing mode is saved before switching to the next computing mode. The context of the computer comprises all data necessary to restore the computer to the state that existed just before switching to the next computing mode. The data that needs to be stored depends on the computer design, but usually includes content of system memory, CPU registers, content of video memory, data in buffers and caches, and data in queues of the microprocessor and other hardware devices. The actual writing of the system context may be achieved by calling appropriate software routines of the operating system of the computer. Similarly, the restore function that reads the system context back into the computing mode may be achieved by calling appropriate software routines of the operating system of the computer.

After the context of the computing mode is saved, the computer is restarted using a cold or warm restart instead of the lengthy reboot process. The previously saved context of the computing mode being entered is restored and the computer resumes operation from the point just before the previous saving of the computer context of the computing mode being re-entered.

In a second embodiment of the present invention the computer context is stored into a storage area or device. The context data is prevented from being accessed by any computing mode other than the one from which the context data was saved. The storage area or device may include but is not limited to flash memory, RAM, disks and CD read/write devices. The limiting of access to only the mode from which the context data was saved minimizes the chance of data contamination between computing modes.

### BREIF DESCRIPTION OF THE DRAWINGS

This invention will be described with reference to the accompanying drawings, wherein:

FIG. 1 shows a block diagram of an implementation of the present invention, and FIG. 2 shows a flow diagram of a software implementation of the present invention.

### DETAILED DESCRIPTION OF THE PREFERRED EMBODIMENT

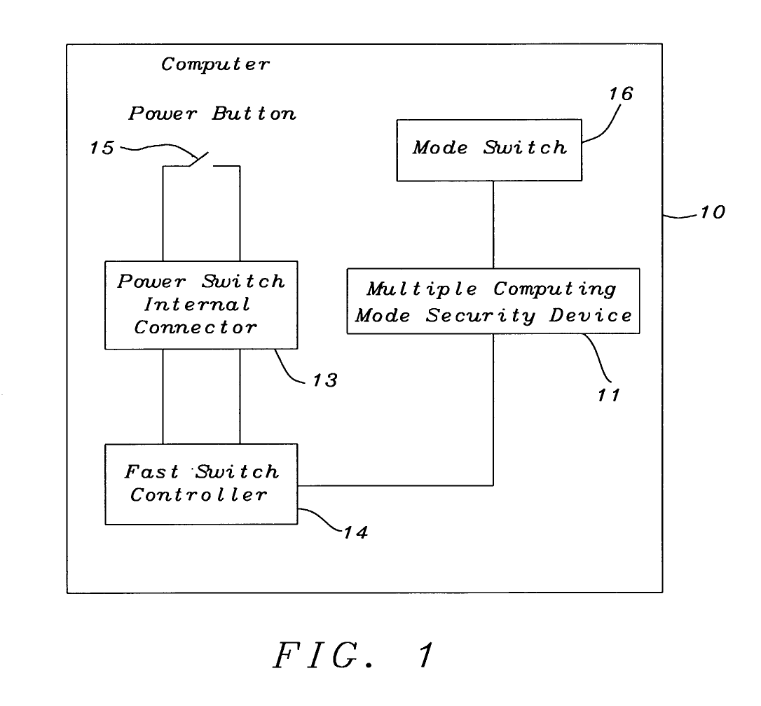

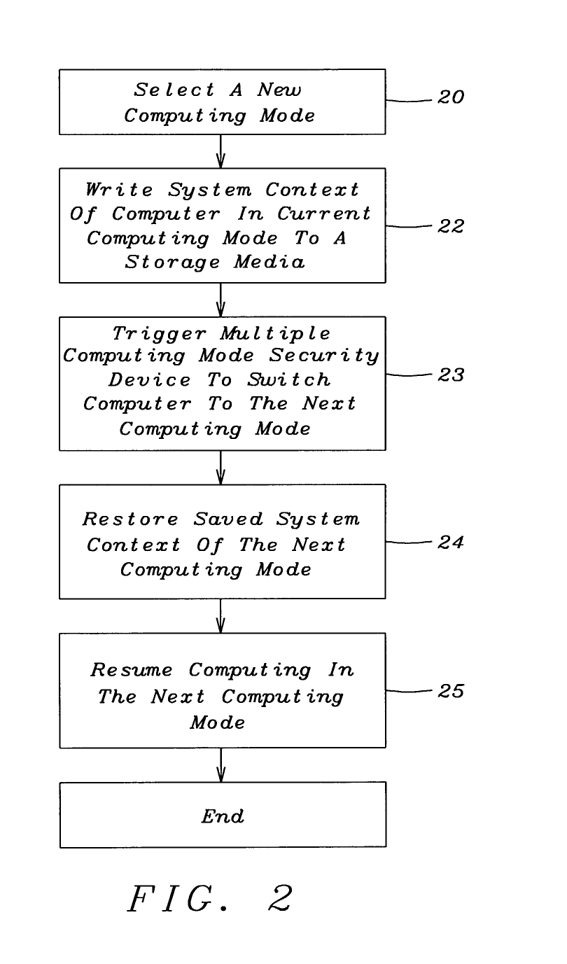

FIG. 1 shows a block diagram of an implementation of the present invention using an Advanced Configuration and Power Interface (ACPI) compatible computer 10 with a multiple computing mode security device 11. The Advanced Configuration and Power Interface is a recently adopted power management standard for computing devices, such as personal computers. ACPI compatible computers must run an operating systems with ACPI support, such as Windows 2000 or Windows XP, and must have ACPI-compatible hardware. The multiple computing mode security device 11 creates multiple computing modes in the computer 10. The multiple computing mode security device could be implemented in various ways, but is preferably configured as shown in U.S. Pat. No. 6,378,074, owned by a common assignee as the present invention, and which is herein incorporated by reference.

In the present invention, switching of power, which can be accomplished at the power switch internal connector 13, which must be configured to put the computer into ACPI hibernation mode (nonvolatile sleep State S4 of the ACPI standard). Pressing the external power button 15 when the computer is running would put the computer into hibernation if the computer was so configured by the user. The computer must be returned to running if the power button 15 is pressed when the computer is in the hibernation mode.

When the user desires to switch to a new computing mode, the user signals the multiple mode security device 11, which sends a signal to the fast switch controller 14. The user can signal the multiple computing mode security device in a variety of ways including pressing a mode switch 16 connected to the multiple computing mode security device, or clicking an icon on the computer screen

The fast switch controller 14 is hardware that coordinates the computing mode switching with the saving and restoring of context data. The fast switch controller 14 first shorts the power switch internal connector 13 to put the computer into hibernation mode; and therefore, saving the context data. Then the fast switch controller 14 signals the multiple computing mode security device 11 to switch to the next computing mode. After the next computing mode is selected, the fast switch controller 14 shorts the power switch internal connector 13 to resume the computer while restoring the context of the next computing mode.

The fast switch controller 14 switches the power at the power switch internal connector 13, putting the computer in hibernation mode. Before the computer goes into hibernation mode, however, the system context for the current computing mode is written to a non-volatile storage media, such as a hard disk. Flash memory or battery backed up RAM may also be used by future operating systems with ACPI support. The context data, which is saved by the operating system will be available to resume computing in the current computing mode when this computing mode is next selected.

Once the computer has been successfully put into hibernation, the fast switch controller 14 sends a signal to the multiple computing mode security device 11 to switch to the next computing mode. The multiple computing mode security device 11 sends a signal back to the fast switch controller 14 when switching to the next computing mode is complete. Upon receiving the signal from the multiple computing mode security device 11, the fast switch controller switches power at the power switch internal connector 13, which triggers the computer to resume working in the next computing mode at the point from which the next computing mode was previously exited. The present invention works on a computer with a power management system that provides an ACPI hibernation (state S4) type function, where the power button can be configured to activate the hibernation state. However, any power management system with a power mode similar to ACPI S4 (i.e., with a power button able to be configured to activate a hibernation state like ACPI S4) may be used with the present invention.

In FIG. 2 is shown a flow diagram of a software implementation of the present invention on a computer with two or more computing modes. Other implementations using another button/switch or a combination of buttons and switches can be configured to perform the functions of the present invention comprising activating hibernation and to activate resume from hibernation. Whereas, the hardware implementation requires an ACPI-compliant operating system, ACPI-compliant hardware and a multiple computing mode security device, a software implementation of the present invention only requires a multiple computing mode security device to create multiple computing modes in the computer system. The ACPI-compliant operating system and the ACPI-compatible hardware are not needed; although, having them simplifies the software implementation.

When a user selects a new computing mode 20, the context of the computer in the current computing mode is saved to, preferably, a non-volatile storage 22. Although, non-volatile storage media is preferred, a volatile storage media can be used where power to the computer is not interrupted during computing mode switching.

After the system context has been saved, the software triggers the multiple computing mode security device to switch the computer to the new computing mode 23. The previously saved system context of the new computing mode is restored 24. The computer resumes work from the point from which the new computing mode 25 had previously been exited. The computer does not go through a lengthy reboot when a new computing mode is selected.

The above software implementation has the advantage that the implementation can be made to work with any operating system and both ACPI and non-ACPI-compliant computing systems. The software implementation provides the same security level as the hardware implementation in which the level of security is determined by the multiple computing mode security device that is chosen. The software implementation does not require an ACPI-compliant operating system allowing various possible software implementations, comprising: a) an implementation that is completely independent of a ACPI-compliant operating system, b) an implementation that uses an ACPI-compliant operating system to simplify saving and restoring context data, and c) an implementation that uses an operating system that provides functions similar to an ACPI-compliant operating system to save and restore context data. The multiple computing mode security device 11, while preferably implemented as described in U.S. Pat. No. 6,378,074, may in the context of the present invention also be provided by at least 2 other techniques. First, the hard disk of a computer is divided into two or more partitions and the computer system may also have one or more network or communication lines that could be connected to the computer. Each computing mode defines the hard disk partition or partitions that are accessible and the network or communication lines that are connected to the computer in the computing mode. The hardware checks every disk access and blocks the attempted access to partitions that are not suppose to be accessible in the current computing mode. Second, it could be implemented using an encryption technique, in which the hard disk of a computer system is divided into two or more sections. Each section is encrypted using a separate key. Only the encryption key of the section, or sections, of the hard drive accessible in the current computing mode is made available. The encryption technique is not limited to a single hard disk and may be extended to multiple hard disks. In addition, each computing mode may also enable selected communication, or network connections, where each connection may be a physical or virtual connection.

While the invention has been particularly shown and described with reference to preferred embodiments thereof, it will be understood by those skilled in the art that various changes in form and details may be made without departing from the spirit and scope of the invention.

What is claimed is:

1. A system to switch computing modes without a reboot, comprising:
a) a computer, comprising
i) a multiple computing mode security device
ii) an external button, operatively coupled to a connector;
b) a fast switch controller, operatively coupled to said connector, and also operatively coupled to said multiple computing mode security device;
c) a context data describing a state of one computing mode of said computer;
d) wherein said computer is configured to put said computer into hibernation mode when a signal is received at said connector and when in a current computing mode, and to return out of hibernation when said signal is received at said connector; and
e) wherein said multiple computing mode security device is configured to communicate to said fast switch controller to send said signal to said connector, so as to put said computer into said hibernation mode, to enter a new computing mode, and to signal said fast switch controller to send another said signal to said connector to return said computer from hibernation mode in said new computing mode.

2. The system of claim 1, further comprising an external power button operatively coupled to a power connector.

3. The system of claim 2, wherein said external button and said external power button perform a same function, and said connector and said power connector are a same connector.

4. The system of claim 1, wherein said context data comprises data from system memory, CPU cache, registers, queues, video memory and/or special device data.

5. The system of claim 1, wherein said context data of said current computing mode is stored when said computer is put into said hibernation mode.

6. The system of claim 1, wherein said context data of the new computing mode is restored to said computer when said computer is switched to said new computing mode.

7. The system of claim 1, wherein said context data of said current and new computing modes is stored in a non-volatile storage device.

8. The system of claim 7, wherein said non-volatile storage device comprises flash memory, hard disk, or battery backed up RAM.

9. The system of claim 1, wherein said context data of said current and new computing modes is stored in a volatile storage media when power to said computer is not allowed to be interrupted during a change in computing modes.

10. The system of claim 1, wherein said context data stored from said current and new computing modes is only accessible while said computer is in said current and new computing modes, respectively.

11. A method of switching between computing modes, comprising:
a) operating a computer in a current computing mode;
b) selecting a next computing mode;
c) storing context data of said current computing mode;
d) switching to said next computing mode;
e) restoring context data of said next computing mode; and
f) resuming computing in said next computing mode.

12. The method of claim 10, wherein said context data comprises computer data sufficient to restore said computer to a state from which the context data was saved.

13. The method of claim 12, wherein context data comprises data saved from system memory, cache, registers, queues and/or video memory.

14. The method of claim 11, wherein storing context data of said current computing mode is done when said computer enters a hibernation mode, prior to exiting said current computing mode.

15. The method of claim 14, wherein storing context data of said current computing mode stores data necessary to later resume computing in said current computing mode at a point where computing was previously stopped.

16. The method of claim 11, wherein restoring context data of said next computing mode is done when said computer exits hibernation mode and upon entering said next computing mode.

17. The method of claim 16, wherein restoring context data of said next computing mode restores data necessary to continue computing in the next computing mode at a point where computing was previously stopped.

18. The method of claim 11, wherein resuming computing in said next computing mode is at the point where computing was stopped previously, when computer was last in said next computing mode.

19. The method of claim 11, wherein switching to said next computing mode from said current computing mode is performed during a hibernation of said computer.

20. A system for switching computing modes, comprising:
a) a means for saving context data of a current computing mode,
b) a means for selecting a next computing mode,
c) a means for resuming computing in said next computing mode.

21. The system of claim 20, wherein said context data is data of said current computing mode that is necessary to resume computing at a point from which said context data was saved.

22. The system of claim 21, wherein context data comprises data from system memory, CPU cache, registers, queues, video memory and/or special device.

23. The system of claim 20, wherein the means for saving context data of said first computing mode comprises a means for entering computer hibernation mode and saving context data of said current computing mode to a non-volatile storage device.

24. The system of claim 20, wherein the means for resuming computing in said second computing mode comprises a means for restoring context data of said next computing mode and entering the next computing mode from computer hibernation mode.

25. The system of claim 24, wherein the context data of said next computing mode was previously saved when said next computing mode was previously exited.

26. The system of claim 24, wherein the means for saving context data of said current computing mode is done when exiting said first computing mode and entering into a computer hibernation mode.

27. The system of claim 26, wherein said context data of said current computing mode is data necessary to resume computing in said current computing mode at the point where the context data of the current computing mode was saved.

28. The system of claim 26, wherein the means for saving context data of said current computing mode further comprises using non-volatile storage when computer power is interruptible, and volatile storage when computer power is not uninterrupted.

29. The system of claim 28, wherein said non-volatile storage is selected from the group comprising flash memory, hard disk drives and battery backed up RAM.

30. A method for switching computing modes, comprising:
a) saving context data of a current computing mode,
b) selecting a next computing mode, and
c) resuming computing in said next computing mode.
